(19) United States
(12) Patent Application Publication
(10) Pub. No.: US 2009/0219497 A1
(43) Pub. Date: Sep. 3, 2009

(54) OPTICAL DEVICE WITH STIFF HOUSING

(75) Inventors: Armin Schoeppach, Aalen (DE); Jens Kugler, Aalen (DE)

Correspondence Address: FISH & RICHARDSON PC, P.O. BOX 1022, MINNEAPOLIS, MN, 55440-1022, US

(73) Assignee: Carl Zeiss SMT AG, Oberkochen (DE)

(21) Appl. No.: 12/390,849

(22) Filed: Feb. 23, 2009

Related U.S. Application Data
(60) Provisional application No. 61/032,128, filed on Feb. 28, 2008.

(51) Int. Cl. G03B 27/70; G02B 7/182; G02B 27/64

(52) U.S. Cl. 355/66; 359/871; 359/555

(57) ABSTRACT

The disclosure relates to an optical device, such as for microlithography, that includes an optical module and a supporting structure. The disclosure also relates to an optical module that includes an optical element and a carrier structure for the optical element. the carrier structure can be connected to the optical element via at least one holding element. The carrier structure can be fixed to the supporting structure and produced, for example, from a material having a coefficient of thermal expansion α<0.2*10⁻⁶K⁻¹.

### CROSS-REFERENCE TO RELATED APPLICATIONS

This application claims the benefit of U.S. Application Ser. No. 61/032,128, filed Feb. 28, 2008, which is incorporated by reference herein.

### FIELD

The disclosure relates to an optical device, such as for microlithography, that includes an optical module and a supporting structure. The disclosure also relates to an optical module that includes an optical element and a carrier structure for the optical element. the carrier structure can be connected to the optical element via at least one holding element. The carrier structure can be fixed to the supporting structure and produced, for example, from a material having a coefficient of thermal expansion α<0.2*10⁻⁶K⁻¹.

### BACKGROUND

In microlithography, it is often desirable to control the position and geometry of optical modules containing optical elements (e.g., lenses, mirrors or gratings), as well as other elements (e.g., mask, substrate). In certain known microlithography systems, the ceramic material Zerodur® (Schott AG, Mainz, Germany) is used for a supporting structure and a carrier structure of an optical element. Zerodur® has a coefficient of thermal expansion of at most 0.1*10⁻⁶K⁻¹ and a thermal conductivity of 1.46 W/mK at 20° C.

### SUMMARY

In some embodiments, the disclosure provides an optical device which can be made more robust and stiffer and can permit enhanced imaging accuracy.

The disclosure is based, in part at least, on the insight that the imaging accuracy that can be obtained, such as in EUV lithography, can be increased by producing the supporting structure and the carrier structure from different materials. In certain instances, only the carrier structure is concerned with regard to reducing (e.g., minimizing) the coefficient of thermal expansion. With regard to the supporting structure, by contrast, the coefficient of thermal expansion can be greater, and the supporting structure and the carrier structure of the optical module can have different coefficients of thermal expansion.

Optionally, the supporting structure can be made significantly stiffer, which can also be due to the stiffness of the materials used. However, the stiffness is increased by considering (e.g., optimizing) the spatial configuration of the supporting structure as such. This is because the flexibility gained in the material used can give rise to significantly more freedom with regard to the spatial construction of the supporting structure. Moreover, the use of a suitable material for the supporting structure also makes it possible to realize connections between the individual elements of the supporting structure which were not able to be realized previously. This can have positive effects on the spatial configuration of the supporting structure, and can permit a significantly more robust and hence overall stiffer connection of the individual elements of which the supporting structure is essentially composed. An improvement in the stiffness can also achieved via the supporting structure being manufactured in a manner closer to final contours.

Generally, two different thermal expansion properties meet one another in the connection between the carrier structure and the supporting structure, which can lead to increased stresses. Such an effect can be reduced (e.g., avoided), for example, if the carrier structure is mounted via at least one bearing element which compensates for different expansions between the carrier structure and the supporting structure. This can be true even if the carrier structure can no longer contribute to the stiffening of the supporting structure and thus reduces the stiffness of the supporting structure in this respect.

The disclosure is based, in part at least, on the insight that a supporting structure of an optical device despite a significant weakening, can nevertheless be made stiffer overall and ultimately assist in achieveing good imaging accuracies.

In some embodiments, the disclosure provides an optical device, such as for microlithography, that includes an optical module and a supporting structure. The optical module includes an optical element and a carrier structure for the optical element. The carrier structure is connected to the optical element via at least one holding element. The carrier structure is fixed to the supporting structure and is produced from a material having a coefficient of thermal expansion α<0.2*10⁻⁶K⁻¹. The carrier structure is fixed to the supporting structure via at least one bearing element which compensates for different expansions between the carrier structure and the supporting structure.

### BRIEF DESCRIPTION OF THE DRAWINGS

Various embodiments and advantages will become apparent from the disclosure in conjunction with the figures, in which:

FIG. 1 is a schematic illustration of an optical imaging device;

FIG. 2 is a schematic illustration of an optical module (connected to a supporting structure) of the optical device from FIG. 1;

FIG. 3 is an illustration of a bearing element for an imaging device;

FIG. 4 is an illustration of a bearing element for an imaging device;

FIG. 5 is an illustration of a bearing element for an imaging device in a state connected to a carrier structure and a supporting structure, and

FIG. 6 is a plan view of an arrangement including optical module in which the bearing elements and the supporting structure are in accordance with FIG. 5.

### DETAILED DESCRIPTION

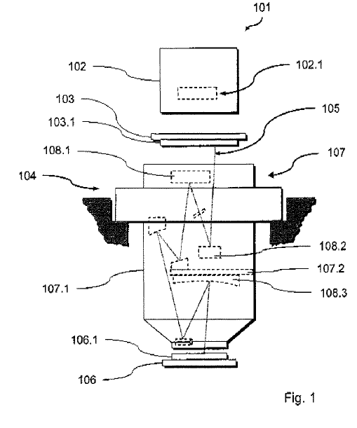

FIG. 1 shows an optical imaging device 101 in the form of a lithography system which can be used in semiconductor fabrication. The imaging device 101 includes an illumination unit 102 including illumination mechanism 102.1 for generating a radiation having wavelengths in the extreme ultraviolet range (EUV). The illustrated exemplary embodiment of the imaging device 101 operates with UV radiation having a wavelength of approximately 13 nm.

The EUV radiation generated by the illumination unit is directed onto a mask 103.1 held by a mask carrier 103. In this case, the mask 103.1 contains a partly transparent pattern, and therefore permits the impinging radiation to pass through the mask 103.1 only at specific locations and to enter into an optical device 104 in the form of a projection device. In this case, the optical device 104 serves for focusing the EUV radiation 105 transmitted through the mask 103.1 onto a substrate 106.1 held in a substrate carrier 106, wherein the substrate is a wafer slice composed of silicon or the like in the exemplary embodiment illustrated.

The projection device 104 has a supporting structure 107 including an outer housing 107.1 and inner supporting elements 107.2, of which, for the sake of clarity, only one supporting element 107.2 is illustrated and moreover only purely schematically in FIG. 1. Overall, the supporting structure 107 is assembled from a series of individual components connected to one another, in which case, in principle, there is no need for any differentiation with regard to specific housing elements 107.1 and supporting elements 107.2, for which reason reference is made hereafter only to the supporting structure as such. FIG. 1 does not illustrate in specific detail that the supporting structure 107 is essentially assembled from plates connected to one another.

Optical modules 108.1, 108.2, 108.3 with their carrier structures 109 are fixed to the supporting structure 107 illustrated in FIG. 1. The optical modules 108.1, 108.2, 108.3 have corresponding optical elements 110 which direct the EUV radiation 105 through the optical device 104 and ultimately focus it onto the substrate 106. On account of the extremely small wavelength of the EUV radiation 105 used, generallyonly reflective optical modules 106 in the form of mirror elements are provided in the case of the illustrated exemplary embodiment of the optical device 104. If the exemplary embodiment operates at other wavelengths, however, any desired optical modules can be used. The optical elements of the optical modules can then act reflectively, refractively or diffractively.

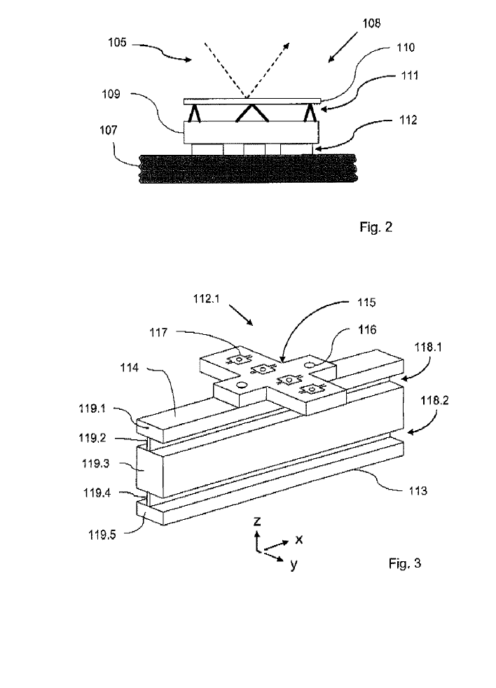

A schematic illustration of an optical module 108 of the optical device 104, the optical module being connected to the supporting structure 107, is illustrated in FIG. 2. The optical module 108 includes a carrier structure 109, the task of which essentially consists in carrying an optical element 110. The optical element is embodied in the form of a mirror element for the reflection of the impinging EUV radiation 105 and is supported against the carrier structure 109 with the aid of a holding element 111. By comparison with the holding element 111, the carrier structure 109 is embodied in significantly more solid fashion in order to achieve a positionally stable positioning of the optical element 110.

In the exemplary embodiment illustrated, the holding element 111 is embodied in the form of schematically illustrated actuators that are coordinated with one another. In the exemplary embodiment illustrated, the actuators of the holding element 111 form a static bearing of the optical element 110 relative to the carrier structure 109. The actuators can be driven electrically, whereby the length of the actuators is varied depending on the situation in order to ensure an exact orientation of the optical element. In the exemplary embodiment illustrated, the holding element 111 ultimately serves for the fine alignment of the optical element. This can also be achieved by the holding element 111 being embodied as an aligning device which enables an exact positioning of the optical element 110 in a purely mechanical manner. In the simplest case, however, the holding element 111 serves as a receptacle for the optical element 110, which, consequently, is not fixed directly to the carrier structure 109.

In order to keep disturbing external influences away from the optical element 110, which influences can be temperature-induced stresses, for instance, the carrier structure 109 is produced from a material having a relatively small coefficient of thermal expansion. In the exemplary embodiment illustrated, the coefficient of thermal expansion is not greater than 0.1*10⁻⁶K⁻¹. The material is a glass ceramic which is produced by Schott AG and bears the product name Zerodur. In principle, however, other glass ceramic materials or other ceramic materials are also appropriate. Optionally, these materials have a coefficient of thermal expansion α<0.2*10⁻⁶K⁻¹.

The supporting structure 107, only a portion of which is illustrated in FIG. 2, is produced from a different material from the carrier structure 109. A relatively small coefficient of thermal expansion is not of primary consideration in the case of the supporting structure 107, even though a small coefficient of thermal expansion for the material of the supporting structure 107 is advantageous. The potential disadvantages are deliberately accepted with regard to the thermal expansion behavior, however, if the advantages of the material used compensate for the potential disadvantages again. In this case, particular attention is paid to the stiffness of the supporting structure 107 as such. In this case, the stiffness of the supporting structure 107 is determined by the choice of material and by the interconnection of the individual components that form the supporting structure 107 as such.

In the exemplary embodiment illustrated in FIG. 2, the supporting structure 107 is formed from a metallic material that provides a high stiffness in the form of a high modulus of elasticity. It can be particularly desirable for the material to permit the use of a very robust connecting technique that could not be used particularly in conjunction with the material Zerodur.

The material used in the exemplary embodiment illustrated is a metal having a so-called Invar effect. This involves a group of alloys for which a very small coefficient of thermal expansion occurs given a specific composition in specific temperature ranges. Even though other alloys are possible, the metal used is an iron-nickel alloy including a nickel content of 30 to 40% by weight, which can be FeNi36 or Fe65Ni35. Alloys having an Invar effect can have coefficients of thermal expansion of α≧0.5*10⁻⁶K⁻¹.

As an alternative to a metallic material of the type described above, it is also possible to use a ceramic material for the supporting structure 107 as such. The ceramic components of the supporting structure 107 are then predominantly connected to one another via non-ceramic connecting elements. Such ceramic materials can belong to the group of silicon carbides, in which case, depending on the intended use, high-purity, hot-pressed, sintered, recrystallized or hot-isostatically pressed silicon carbide can be used. These ceramic materials also lead to a higher configurational freedom and, on account of the materials used, however, also on account of the use of a stiffer connecting technique, to stiffer supporting structures 107.

With the use of ceramic materials, those having a coefficient of thermal expansion of α≧0.4*10⁻⁶K⁻¹ are appropriate. Typically, the coefficient of thermal expansion does not exceed a value of 3.0*10⁻⁶K⁻¹, however. The silicon carbide compounds that can enable coefficients of thermal expansion of α≧2.6*10⁻⁶K⁻¹. The same also applies to the use of ceramic fiber composite materials, which likewise enable stiffer supporting structures to be provided. These materials have a ceramic matrix into which either ceramic or non-ceramic fibers such as carbon fibers, for instance, are introduced. The material properties of the ceramic fiber composite materials are highly dependent on the (preferred) fiber directions. In this respect, the material properties can be set overall, on the one hand, but also with regard to a very specific preferred direction, on the other hand. Thus, in the case of ceramic fiber composite materials, the thermal expansion in the fiber direction can be set to α<0.5*10⁻⁶K⁻¹.

In addition, the use of a metallic material instead of the glass ceramic mentioned also leads to a high thermal conductivity of the supporting structure 107, which is then λ>10 W/mK (e.g., λ>40 W/mK), while the thermal conductivity of the carrier structure 109 is significantly lower and does not exceed 1.5 W/mK in the exemplary embodiment illustrated. If desired, the supporting structure 109 could also have a thermal conductivity of λ>40 W/mK. If the carrier structure 109 is produced by resorting to a different material rather than Zerodur, then this can also involve a ceramic material having a thermal conductivity of λ≦3.0 W/mK.

Owing to the higher thermal conductivity of the supporting structure 107, heat can be drawn from the optical device 104 more rapidly and more uniformly via a corresponding cooling. In this way, the temperature gradients of the optical device 104 can be kept very small. This ultimately leads to lower stresses and to higher accuracies during the EUV lithography. The same also correspondingly holds true when using supporting structures 107 composed of a ceramic material instead of a metallic material. The thermal conductivity of the material can then readily be λ≧40 W/mK or even λ≧100 W/mK. This holds true for example in principle for the material silicon carbide having a thermal conductivity of 150 W/mK.

Lower thermal conductivities are provided if the supporting structure 107 is constructed from a ceramic fiber composite material, in which case the corresponding thermal conductivities are regularly at least 15 W/mK, however. In contrast to the thermal expansion, the thermal conduction parallel to the fiber direction of the ceramic fiber composite materials is significantly greater than in a direction perpendicular to the fibers.

The use of two different materials for the supporting structure 107, on the one hand, and the carrier structure 109 for the optical element 110, on the other hand, becomes practicable, owing to the different thermal expansion behavior of the carrier structure 109 and of the supporting structure 107, only by using a suitable bearing 112 of the carrier structure 109 on the supporting structure 107.

Bearings 112 including bearing elements which can compensate for expansion differences—which occur on account of the temperature difference with respect to a desired temperature—between the carrier structure 109 and the supporting structure 107 are appropriate here, in principle. For dynamic reasons, a relatively stiff connection between the supporting structure 107 and the carrier structure 109 of the optical module 108 is additionally desired in order to enable a highly accurate alignment of the optical element 110 and to avoid an excitation of oscillations as a result of a high natural frequency. In the case of the optical module illustrated in FIG. 2, which weighs approximately 30 kg including mirror, mirror carrier and actuator system, a minimum stiffness of approximately 0.1*10⁶ N/mm perpendicular to and in the direction of the mirror axis is provided, and as desired is also 0.5*10⁶ N/mm or even 1.0*10⁶ N/mm.

The use of a different material for the supporting structure 107 in comparison with the carrier structure 109 becomes practicable only by using a suitable bearing 112 for the carrier structure 109 which is stiff enough to fix the carrier structure 109 and to compensate for different thermal length-specific expansions between carrier structure 109 and supporting structure 107 if the temperature of the carrier structure 109 and/or of the supporting structure 107 deviates from a desired temperature or operating temperature by a certain magnitude. This enables not only compensation of the thermal expansion but also greater configurational freedoms that are attributed to the material of the supporting structure 107, but to the connecting techniques that are possible as a result. In addition, the proposed bearing 112 is more tolerant of damage with regard to the carrier structure 109 and the supporting structure 107 since mounting and production tolerances can be compensated for. Stresses which can lead to inaccuracies but also to fracture damage of the materials used are ultimately avoided.

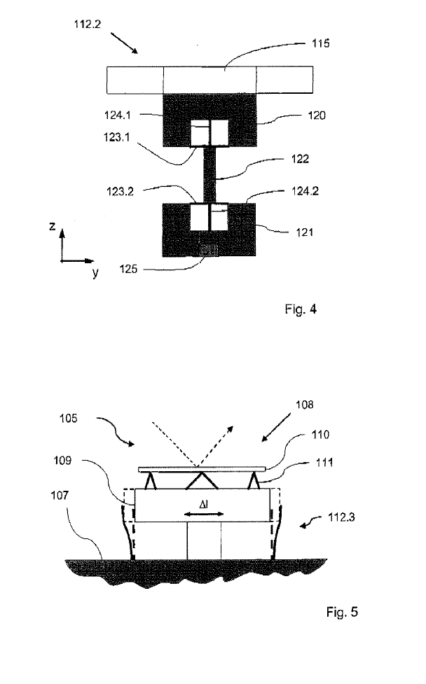

The bearing 112—which is only illustrated schematically in FIG. 2—of the carrier structure 109 on the supporting structure 107 includes bearing elements 112.1, which are illustrated in greater detail in FIG. 3 and which enable for example a statically determined bearing 112 of the carrier structure 109 on the supporting structure 107. For this purpose, three separate bearing elements 112.1 of the type illustrated in FIG. 3 can be used for fixing a carrier structure 109 to the supporting structure 107. As an alternative, it is also possible to use three of the bearing elements 112.2 illustrated in FIG. 4, since both bearing elements 112.1, 112.2 have a similar characteristic. The bearing elements 112.1, 112.2 illustrated in FIGS. 3 and 4 have a very high stiffness in their longitudinal direction, whereas this is not the case in the transverse direction. Moreover, a high stiffness is provided by the shaping of the bearing elements 112.1, 112.2 also in a connecting direction between the carrier structure 109 and the supporting structure 107, wherein the connecting direction is perpendicular to the plane spanned by the longitudinal direction and the transverse direction.

FIG. 3 does not illustrate in specific detail that the bearing element 112.1 is connected to the supporting structure 107 by its surface 113 facing downward in the orientation illustrated, wherein a cohesive connection is appropriate. A connecting element 115 for attaching the carrier structure 109 is provided at the end 114 of the bearing element 112.1, this end being illustrated as facing upward in FIG. 2. In the exemplary embodiment illustrated in FIG. 3, the connecting element 115 is fixed via corresponding screws 116, while the connection to the carrier structure 109 is closed via a series of adhesive locations 117. The adhesive bonding of the bearing element 112.1 to the carrier structure 109 which arises from the individual adhesive locations 117 is effected transversely with respect to the bearing element 112.1, which has a pronounced longitudinal direction. The adhesive locations 117 are situated on portions of the connecting element 115 which are flexible in the y direction. The flexibility is achieved via suitable cutouts 117.1 in the connecting element 115. As a result, the connecting element 115, which can produced from a metallic material, cannot produce deformation in the carrier structure 109 in the event of a thermal expansion. At the same time, however, the connecting location between carrier structure 109 and bearing element 112.1 acquires an increased stiffness. The dimension of the bearing element 112.1 is larger by a multiple in the longitudinal direction (x direction) than in a direction transversely with respect to the bearing element 112.1 (y direction).

The bearing element 112.1 additionally also has two portions for weakening the stiffness of the bearing element 112.1 in the transverse direction (y direction), the portions constituting cross-sectional taperings 118.1, 118.2 relative to a cross section perpendicular to the longitudinal direction of the bearing element 112.1. In principle, just one corresponding tapering or else still further corresponding taperings could also be provided. The cross section of the bearing element 112.1 illustrated in FIG. 3 perpendicular to the longitudinal extent is subdivided into five portions 119.1, 119.2, 119.3, 119.4, 119.5, which, as illustrated, can have a rectangular cross section. The portions 119.2, 119.4 in which the cross section is tapered provide for a rotational degree of freedom about an axis parallel to the longitudinal extent of the bearing element 112.1. Furthermore, the portions 119.2, 119.4 are made long enough that the portions 119.1, 119.3, 119.5 can also be displaced relative to one another in the y direction, even though this displacement can only be effected over short distances. The bearing element 119.1 illustrated thus provides, for the connection between carrier structure 109 and supporting structure 107, a fixing in the z and x directions and approximately a decoupling with regard to the remaining degrees of freedom, and ultimately also has a degree of freedom in the y direction. In principle, these degrees of freedom could also be achieved by only one portion having a cross-sectional tapering. The bearing element is nevertheless made very stiff in the longitudinal direction and the connecting direction.

FIG. 4 illustrates a further exemplary embodiment of a bearing element 112.2, suitable for a statically determined bearing 112 of carrier structure 109 and supporting structure 107, in a section in a plane perpendicular to the x axis in accordance with FIG. 3. In this case, the basic construction of the bearing element 112.2 corresponds to the bearing element 112.1 illustrated in FIG. 3. The bearing element 112.2 illustrated in FIG. 4 also is significantly longer than wide or high and has a portion having a cross-sectional tapering 118.3 relative to a cross section perpendicular to the longitudinal extent of the bearing element 112.2. This cross-sectional tapering 118.3 provides for a degree of freedom with respect to a rotation about at least one axis parallel to the longitudinal extent of the bearing element 112.2, which runs perpendicular to the plane of the drawing in the case of the exemplary embodiment illustrated. In the present case, there are two rotation axes running at the transitions between a head element 120 and a foot element 121 in each case with respect to an intermediate element 122. At the the transitions, provision is made of connecting elements 123.1, 123.2, 124.1, 124.2 in the form of spring elements, which run in the connecting direction (z direction) and transverse direction (y direction) and can be deformed in the case of a rotation about two rotation axes. As a result, a deformation of the intermediate element 122 is not necessary in order to displace the head element 120 and the foot element 121 relative to one another in the transverse direction (y direction).

As a further difference between the bearing elements 112.1, 112.2 illustrated in FIGS. 3 and 4 there is the actuator 125, which enables a lengthening or a shortening of the bearing element 112.2 in the connecting direction (z direction). Upon actuation of the actuator, which in this case increases or shortens its length in the z direction, a force acts on the connecting elements 123.2, 124.2, which displace the intermediate element 122 parallel to the z direction. Via the restoring forces of the connecting elements 123.1, 124.1 this ultimately leads to an adaptation of the height of the bearing element 112.2.

The construction of the bearing elements 112.1, 112.2 illustrated in FIGS. 3 and 4 can be modified if desired without thereby losing the basic properties described above. It can be particularly desirable for one bearing element to be stiff at least in one direction (e.g., plane) which can be parallel to a plane of the mirror element or a plane of the carrier structure. In another direction, which is perpendicular to the first direction and likewise parallel to a mirror plane or a plane of the carrier structure, the bearing element has a low stiffness, however. Perpendicular to the plane or to the first and to the second direction, the bearing element is then embodied as stiff again. The bearing elements of this type have at least one weakening which results in a rotational and/or a translational degree of freedom, which is respectively characterized by a low stiffness of the bearing element with regard to a corresponding displacement and/or rotation in the respective direction.

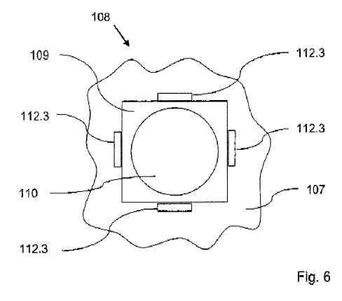

FIGS. 5 and 6 illustrate another possible arrangement of bearing elements 112.3. The deformed state is illustrated in dashed fashion in FIG. 5. Under loading, such as on account of a different thermal expansion of carrier structure 109 and supporting structure 107, a deformation of the bearing elements 112.3 occurs, which compensates for the length changes Δ1 on account of a temperature change, which is illustrated by the dashed line in FIG. 5. The contour of the carrier structure 109 that is illustrated in dashed fashion arises in the event of a heating of the carrier structure 109 that results from the EUV radiation 105. In contrast to the carrier structure 109, the supporting structure 107 is actively cooled and therefore maintains its desired temperature. The carrier structure 109 is essentially decoupled from the cooling of the supporting structure 107 via the bearing elements 112.3. The carrier structure 109 therefore expands slightly by the length difference Δ1, even though the carrier structure 109 is composed of Zerodur or the like with a very low coefficient of thermal expansion of less than 0.2*10⁻⁶K⁻¹, since it is heated by the thermal power on account of the EUV radiation and the actuator system. In principle, however, the bearing element 112.3 can also expand relative to the supporting structure 107.

The bearing elements 112.3 have two mutually perpendicular preferred directions which lie in a plane defined by the respective bearing element 112.3 and are characterized by a very high stiffness. Perpendicular to this plane, the bearing element 112.3 has a significantly lower stiffness on account of a configuration that is thin or overall planar in this direction. The holding element 111 is configured in the same way as the holding element 111 illustrated in FIG. 3 and connects the optical element 110 to the carrier structure 109 in statically determined fashion via actuators.

FIG. 6 illustrates four bearing elements 112.3 of identical type. Two of the bearing elements 112.3 in each case are connected to one another by the straight lines 126.1, 126.2, wherein the straight lines are in each case perpendicular to the planes defined by the bearing elements 112.3. The straight lines 126.1 126.2 intersect at a point which can coincide with the midpoint with respect to all four bearing elements 112.3. As an alternative or in addition, the straight lines 126.1, 126.2 run through the respective midpoints or centroids of the bearing elements 112.3 illustrated. The carrier structure is therefore firstly fixed to the supporting structure 107 in statically overdetermined fashion, but given a suitable choice of the point of intersection of the straight lines 126.1, 126.2 this nevertheless does not produce any constraints in the carrier structure 109 in the event of a relative expansion with respect to the supporting structure 107 on account of a thermal expansion or contraction. As an alternative, a statically determined bearing via three of the bearing elements 112.3 illustrated in FIGS. 5 and 6 would also be conceivable. Analogously to this, it is also possible to provide four of the bearing elements 112.1, 112.2 illustrated in FIGS. 3 and 4 between the carrier structure 109 and the supporting structure 107.

The components of the optical module illustrated in FIG. 5 correspond to the components which have already been illustrated in FIG. 2 and correspondingly described. For this reason, identical components also bear identical reference symbols.

What is claimed is:

1. An optical device, comprising:
an optical element;
a carrier structure;
a holding element that connects the optical element to the carrier structure;
a supporting structure; and
a bearing element that fixes the carrier structure to the supporting structure, wherein:
the bearing element is configured to compensate for different expansions between the carrier structure and the supporting structure;
the carrier structure comprises a material having a coefficient of thermal expansion that is less than 0.2*10⁻⁶K⁻¹; and
the optical device is configured to be used in microlithography.

2. The optical device according to claim 1, wherein a first side of the holding element is connected to the optical element, a second side of the holding element is connected to the carrier structure, and the first side of the holding element is different from the the second side of the holding element.

3. The optical device according to claim 2, wherein the holding element is an aligning device configured to orient the optical element.

4. The optical device according to claim 3, wherein the holding element comprises at least one electrically drivable actuator configured to orient the optical element.

5. The optical device according to claim 1, wherein the bearing element is configured so that it is significantly stiffer in a first plane than in a direction perpendicular to the first plane.

6. The optical device according to claim 1, wherein the bearing element has a translational degree of freedom in a direction perpendicular to a plane of the bearing element that is spanned by a longitudinal extent and the connecting direction.

7. The optical device according to any of claim 1, wherein a length of the bearing element is greater than a width of the bearing element.

8. The optical device according to claim 1, wherein a cross section of the bearing element in a plane perpendicular to a longitudinal extent of the bearing element has a cross-sectional tapering.

9. The optical device according to claim 8, wherein the cross-sectional tapering is configured to impart a translational degree of freedom to the bearing element.

10. The optical device according to claim 1, wherein a cross section of the bearing element in a plane perpendicular to the longitudinal extent of the bearing element has at least two cross-sectional taperings.

11. The optical device according to claim 10, wherein the at least two cross-sectional taperings are oriented with respect to one another in such a way as to impart a translational degree of freedom to the bearing element.

12. The optical device according to claim 1, wherein the bearing is a statically determined bearing.

13. The optical device according to claim 1, wherein optical device comprises three bearing elements that fix the carrier structure to the supporting structure, and the three bearing elements are of identical type.

14. The optical device according to claim 1, wherein optical device comprises four bearing elements that fix the carrier structure to the supporting structure, and the four bearing elements are of identical type.

15. The optical device according to claim 1, wherein the bearing element is a ductile bearing elements.

16. The optical device according to claim 1, wherein optical device comprises two bearing elements having the same orientation.

17. The optical device according to claim 1, wherein optical device comprises two bearing elements oriented perpendicular to one another.

18. The optical device according to claim 1, wherein the supporting structure comprises a metallic material.

19. The optical device according to claim 18, wherein the metallic material has an Invar effect.

20. The optical device according to claim 1, wherein the supporting structure comprises an iron-nickel alloy comprising between 30% by weight and 40% by weight nickel.

21. The optical device according to claim 1, wherein the supporting structure comprises a silicon carbide.

22. The optical device according to claim 1, wherein the supporting structure comprises a material selected from the group consisting of high-purity silicon carbide, hot-pressed silicon carbide, sintered silicon carbide, recrystallized silicon carbide, and hot-isostatically pressed SiC.

23. The optical device according to claim 1, wherein at least portions of the supporting structure comprises a ceramic fiber composite material.

24. The optical device according to claim 1, wherein at least portions of the supporting structure comprise a material selected from the group consisting of a carbon-fiber-reinforced silicon carbide and silicon-carbide-fiber-reinforced silicon carbide.

25. The optical device according to claim 1, wherein the supporting structure comprises a material having a coefficient of thermal expansion that is greater than or equal to 0.4*10⁻⁶K⁻¹.

26. The optical device according to claim 1, wherein the supporting structure comprises a material having a coefficient of thermal expansion that is greater than or equal to 1.0*10⁻⁶K⁻¹.

27. The optical device according to claim 1, wherein the supporting structure comprises a material having a coefficient of thermal expansion that is greater than or equal to 2.6*10⁻⁶K⁻¹.

28. The optical device according to claim 1, wherein the carrier structure comprises a material having a thermal conductivity that is less than or equal to 3.0 W/mK.

29. The optical device according to claim 1, wherein the carrier structure comprises a material having a thermal conductivity of that is less than or equal to 1.5 W/mK.

30. The optical device according to claim 1, wherein the supporting structure comprises a material having a thermal conductivity that is greater than or equal to 15 W/mK.

31. The optical device according to claim 1, wherein the supporting structure comprises a material having a thermal conductivity that is greater than or equal to 40 W/mK.

32. The optical device according to claim 1, wherein the supporting structure comprises a material having a thermal conductivity that is greater than or equal to 100 W/mK.

33. The optical device according to claim 1, wherein the optical module and the supporting structure are configured to be used in extreme ultraviolet radiation microlithography.

34. The optical device according to claim 1, wherein the optical element is a mirror.

35. The optical device according to claim 1, wherein the carrier structure comprises a ceramic material.

36. The optical device according to claim 1, wherein the carrier structure comprises a material having a coefficient of thermal expansion of less than or equial to 0.1*10⁻⁶K⁻¹.

37. The optical device according to claim 1, wherein the carrier structure comprises a glass ceramic.

38. The optical device according to claim 1, wherein the carrier structure comprises Zerodur.

39. The optical device according to claim 1, wherein the supporting structure is a frame structure for the optical module.

40. The optical device according to claim 39, wherein the supporting structure ia a housing for the optical module.

41. An optical imaging device, comprising:
an illumination unit; and
a projection device, comprising:
an optical element;
a carrier structure;
a holding element that connects the optical element to the carrier structure;
a supporting structure; and
a bearing element that fixes the carrier structure to the supporting structure,
wherein:
the bearing element is configured to compensate for different expansions between the carrier structure and the supporting structure;
the carrier structure comprises a material having a coefficient of thermal expansion that is less than 0.2*10⁻⁶K⁻¹; and
the optical imaging device is configured to be used in microlithography.
